(19) United States
(12) Patent Application Publication
(10) Pub. No.: US 2016/0086744 A1
(43) Pub. Date: Mar. 24, 2016

(54) GAS-INSULATED SWITCHGEAR

(71) Applicant: MITSUBISHI ELECTRIC CORPORATION, Chiyoda-ku, Tokyo (JP)

(72) Inventor: Shunsuke TASAKA, Chiyoda-ku, Tokyo (JP)

(73) Assignee: MITSUBISHI ELECTRIC CORPORATION, Chiyoda-ku, Tokyo (JP)

(21) Appl. No.: 14/652,588

(22) PCT Filed: Apr. 12, 2013
(86) PCT No.: PCT/JP2013/061089

§ 371 Date: Jun. 16, 2015

(51) Int. Cl. H01H 9/02

(52) U.S. Cl. CPC H01H 9/02; H01H 2009/0292; H01H 2223/002

(57) ABSTRACT

An isolator container is provided with a view window having an oval shape with the long diameter in the direction of an axis. The view window is provided at a position facing a movable contact of an isolator, or at a position facing a contact point between the movable contact of the isolator and a fixed contact of the isolator; and at least the contact point is within a visible range therethrough. The length of the long diameter of the view window is set such that surfaces of insulating spacers are within the visible range of the view window. Because of this configuration, surface states of the insulating spacers and a connection status of the movable contact in the isolator container can be observed without increasing the number of view windows.

### FIELD

The present invention relates to a gas-insulated switchgear.

### BACKGROUND

A gas-insulated switchgear is configured by accommodating therein a plurality of devices such as a breaker, an isolator, and an earth switch in a metal container and sealing insulating gas therein.

A container that accommodates therein an isolator (hereinafter, “isolator container”) is provided with a view window for observing therethrough the connection status of the movable contact of the isolator from outside the isolator container. An earth switch is often accommodated in the isolator container as well, and another view window for observing therethrough the connection status of the movable contact of the earth switch from outside the isolator container may be provided in the isolator container.

Conventionally, the view window provided is a circular-shaped view window for the purpose mentioned above and it is at a position where the contact point of the isolator or the earth switch can be visually observed therethrough.

Patent Literature 1 describes an internal inspection device for visually inspecting the inside of a gas-insulated device from outside. The internal inspection device is attached to a circular opening provided in a container of the gas-insulated device. Specifically, a pillar-shaped body of the internal inspection device is inserted into the opening of the container, and it is attached movably in an axial direction and rotatably. The body of the internal inspection device is provided with a lighting optical path that guides light from outside the container to the inside of the container and an inspection optical path that guides light from inside the container to outside of the container. Both of the optical paths have an opening that opens in the axial direction of the body outside of the container and that opens to a side surface of the body inside the container. A mirror for bending light and glass for blocking the light inside and outside of the container are provided along the path. A fish-eye lens is installed at the inside opening of the container of the inspection optical path so as to widen the inspection range. Further, by rotating the body, the inspection range can be widened.

### CITATION LIST

### Patent Literature

Patent Literature 1: Japanese Patent Application Laid-open No. H11-122726

### SUMMARY

### Technical Problem

The conventional view window has a circular shape and a small size, and the visible range that can be observed from outside is limited. Therefore, observation of the internal status other than the vicinity of a contact point has been difficult, and particularly, it has been difficult to observe the surface state of the insulating spacer.

The insulating spacer is provided at an end portion of an isolator container so as to insulate and support a part of an isolator body or a conductor connected to the isolator body. Generally, electric discharge may occur in a boundary between the insulating spacer and a metal being an object to be supported, and the electric discharge becomes a cause of insulation breakdown. If electric discharge occurs, a trace is left on the surface of the insulating spacer inside the isolator container, and thus the presence of the occurrence of electric discharge can be observed by visually checking the surface.

However, conventionally, the visible range seen through the view window has been limited, and it has been difficult to observe the surface state of the insulating spacer through the view window. Therefore, dismantlement of the device is required, and the cost of any dismantling work and the power cut time during any dismantling period need to be set.

If the number of view windows is increased, the surface states of the insulating spacers can be individually observed therethrough. However, because the view window is blocked with a light-transmissive member such as a lens, the observation window may become physically fragile in terms of strength, and when the number of view windows increases, design strength needs to be restudied as to whether the isolator container can endure a high-pressure of gas. Further, an increase in the number of view windows leads to an increase in the manufacturing cost of the isolator container.

Accordingly, a configuration is desired that enables not only observation of the connection status of a movable contact of an isolator but also observation of the surface state of the insulating spacer.

Furthermore, according to the technique in Patent Literature 1, the inspection range can be enlarged by rotating the body of the internal inspection device. However, a dedicated device (an internal inspection device) having more a complicated structure when compared to the view window needs to be provided, and the number of parts also increases in addition to the need to design an installation place and to have an installation method; therefore, it becomes disadvantageous in terms of cost.

The present invention has been achieved in view of the above problems, and an objective of the present invention is to provide a gas-insulated switchgear that can observe a surface state of at least one insulating spacer and a connection status of a movable contact in an isolator container without increasing the number of view windows but still having a simple configuration and in which the view window is provided in the isolator container.

### Solution to Problem

In order to solve the problem and achieve the objective mentioned above, the present invention relates to a gas-insulated switchgear that includes an isolator. The isolator includes: an isolator container provided with a first end portion having a first axis as a central axis and a second end portion different from the first end portion and having a second axis orthogonal or identical to the first axis as a central axis, an isolator body accommodated in the isolator container, connected to a first conductor accommodated in a first container connected to the first end portion, and connected to a second conductor accommodated in a second container connected to the second end portion, a first insulating spacer provided at the first end portion so as to support a fixed contact of the isolator body and the first conductor, a second insulating spacer provided at the second end portion so as to support a conductor on a movable side connected to a movable contact of the isolator body and the second conductor, and a view window that is provided in a cylindrical portion including the first end portion of the isolator container, having the first axis as a central axis, that is provided at a position facing the movable contact of the isolator body or a position facing a contact point between the movable contact of the isolator body and the fixed contact of the isolator body, and that allows at least the contact point to be within a visible range of the view window. The view window is configured to include a light-transmissive member that blocks an opening having an oval shape with a long diameter being in a direction of the first axis, and a length of the long diameter is set such that a surface of the first insulating spacer is present within the visible range.

### Advantageous Effects of Invention

According to the present invention, it becomes possible to observe the surface state of a first insulating spacer and the connection status of a movable contact in an isolator container without increasing the number of view windows but still having a simple configuration and in which the view window is provided in the isolator container.

### BRIEF DESCRIPTION OF DRAWINGS

FIG. 1 is a side view illustrating a configuration of a gas-insulated switchgear according to a first embodiment.

FIG. 2 is a longitudinal sectional view illustrating the configuration of the gas-insulated switchgear according to the first embodiment.

FIG. 3 is a sectional view along the line A-A in FIG. 2.

FIG. 4 is a sectional view along the line B-B in FIG. 3.

FIG. 5 is a side view illustrating a configuration of a conventional gas-insulated switchgear.

FIG. 6 is a longitudinal sectional view illustrating a configuration of the conventional gas-insulated switchgear.

FIG. 7 is a sectional view along the line C-C in FIG. 6.

FIG. 8 is a sectional view along the line D-D in FIG. 7.

FIG. 9 is a side view illustrating a configuration of a gas-insulated switchgear according to a modification of the first embodiment.

FIG. 10 is a longitudinal sectional view illustrating the configuration of the gas-insulated switchgear according to the modification of the first embodiment.

FIG. 11 is a side view illustrating a configuration of a gas-insulated switchgear according to a second embodiment.

FIG. 12 is a longitudinal sectional view illustrating the configuration of the gas-insulated switchgear according to the second embodiment.

FIG. 13 is a sectional view along the line E-E in FIG. 12.

FIG. 14 is a sectional view along the line F-F in FIG. 12.

FIG. 15 is a sectional view along the line G-G in FIG. 13.

FIG. 16 is a side view illustrating a configuration of another conventional gas-insulated switchgear.

FIG. 17 is a longitudinal sectional view illustrating the configuration of the conventional gas-insulated switchgear.

FIG. 18 is a sectional view along the line H-H in FIG. 17.

FIG. 19 is a sectional view along the line I-I in FIG. 18.

### DESCRIPTION OF EMBODIMENTS

Exemplary embodiments of a gas-insulated switchgear according to the present invention will be explained below in detail with reference to the accompanying drawings. The present invention is not limited to the embodiments.

### First Embodiment

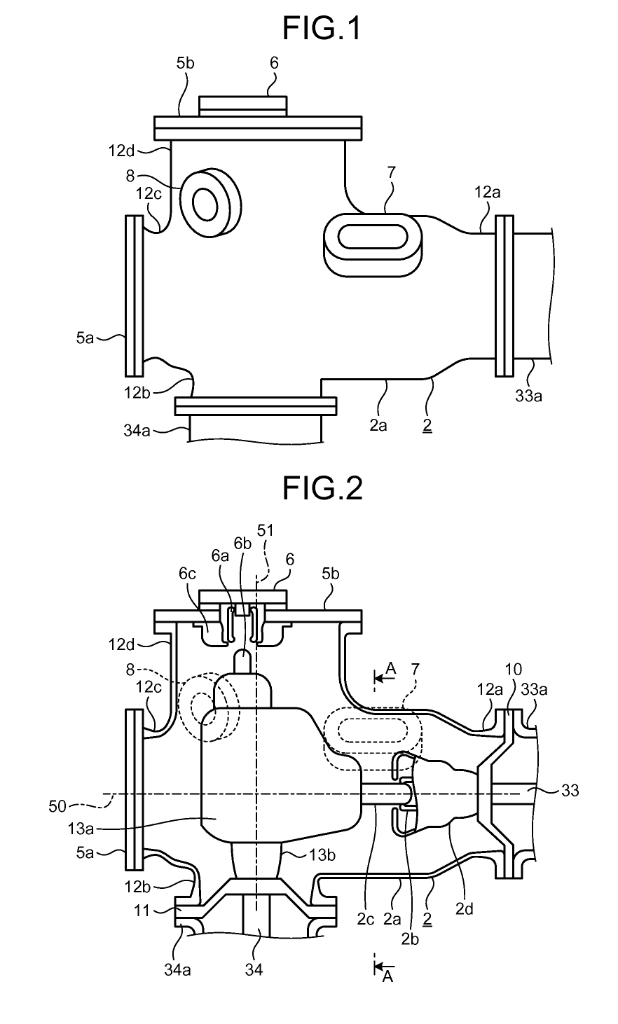

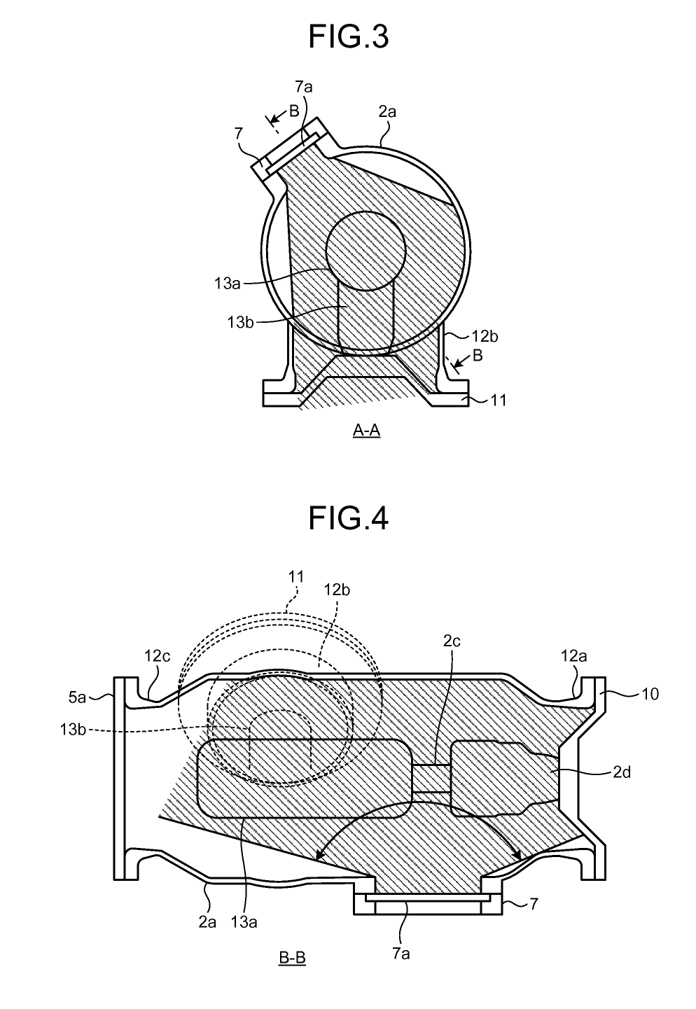

FIG. 1 is a side view illustrating a configuration of a gas-insulated switchgear according to the present embodiment. FIG. 2 is a longitudinal sectional view illustrating the configuration of the gas-insulated switchgear according to the present embodiment. FIG. 3 is a sectional view along the line A-A in FIG. 2; and FIG. 4 is a sectional view along the line B-B in FIG. 3. In FIG. 2, view windows 7 and 8 are both indicated by dotted lines. FIG. 3 is intended to illustrate the visible range seen through the view window 7, and therefore some parts of the configuration are omitted. FIG. 4 is intended to illustrate the visible range seen through the view window 7, and therefore some parts of the configuration are omitted, with an end portion 12b being indicated by a dotted line as well.

As illustrated in FIGS. 1 to 4, the gas-insulated switchgear according to the present embodiment includes an isolator 2 with an isolator body being accommodated in an isolator container 2a; a conductor 33 (first conductor) accommodated in a container 33a (first container) connected to an end portion 12a (first end portion) of the isolator container 2a and also connected to the isolator 2; and a conductor 34 (second conductor) accommodated in a container 34a (second container) connected to the end portion 12b (second end portion) of the isolator container 2a and also connected to the isolator 2. The isolator container 2a and the containers 33a and 34a are metal tanks, and are filled therein with and sealed with an insulating gas, for example, sulfur hexafluoride gas. The conductors 33 and 34 are respectively connected to another gas-insulated device (not illustrated). As described below, the isolator includes a movable contact 2c, a fixed contact 2b, and the like. The gas-insulated switchgear according to the present embodiment can be applied to both of a phase-separated type and a three-phase batch-type gas-insulated switchgear.

The isolator 2 is called an “isolator with an earth switch”, in which the isolator body and an earth switch 6 are integrally formed in the isolator container 2a. The isolator container 2a has a substantially L-shaped form, and includes the cylindrical end portion 12a having an axis 50 (first axis) as a central axis and the cylindrical end portion 12b having an axis 51 (second axis) being substantially orthogonal to the axis 50 as a central axis. The isolator container 2a has a longer size in the direction of the axis 50 than that in the direction of the axis 51; and the end portion 12b is pulled out in the direction of the axis 50 from the cylindrical portion having the axis 51 leading to the end portion 12a as a central axis and is formed in a substantially L-shape.

Specifically, the isolator container 2a includes an end portion 12c provided at an opposite side to the end portion 12a in the direction of the axis 50, and an end portion 12d (third end portion) provided at an opposite side to the end portion 12b in the direction of the axis 51. However, the opening at the end portion 12c is blocked by a lid plate 5a; and the opening at the end portion 12d is blocked by a lid plate 5b.

The end portion 12a of the isolator container 2a is connected to one end portion of the container 33a via an insulating spacer 10 (first insulating spacer). That is, the insulating spacer 10 is provided at an opening of the end portion 12a. The insulating spacer 10 is formed of, for example, an epoxy resin. The insulating spacer 10 insulates and supports a fixed portion of the isolator 2 including the fixed contact 2b and an electric-field relaxation shield 2d covering the fixed contact 2b of the isolator 2, and it is also insulates and supports the conductor 33 connected to the fixed contact 2b. The insulating spacer 10 also supports the fixed contact 2b via the electric-field relaxation shield 2d. Although a fixed-side electrode and the like connected to the fixed contact 2b are present inside of the electric-field relaxation shield 2d, illustrations thereof are omitted.

The end portion 12b of the isolator container 2a is connected to one end portion of the container 34a via an insulating spacer 11 (second insulating spacer). That is, the insulating spacer 11 is provided at an opening at the end portion 12b. The insulating spacer 11 is formed of, for example, an epoxy resin. The insulating spacer 11 insulates and supports both a conductor 13b on a movable side of the isolator 2 and the conductor 34 connected to the conductor 13b. The conductor 13b is connected to the movable contact 2c of the isolator 2 and a movable contact 6b of the earth switch 6. A movable-side electrode, to which the movable contacts 2c and 6b and the conductor 13b are connected, is present on the inside of an electric-field relaxation shield 13a, and illustrations thereof are omitted here.

The movable contact 2c can perform a reciprocal motion along the axis 50, and it comes into contact with the fixed contact 2b or comes away from the fixed contact 2b. Further, the movable contact 6b can perform a reciprocal motion along the axis 51, and it comes into contact with a fixed contact 6a of the earth switch 6 or comes away from the fixed contact 6a. Although illustrations of the configuration inside of the electric-field relaxation shield 13a are omitted, the movable portions are integrally formed so that, when the isolator 2 is in a connected state, the earth switch 6 is in a released state, and when the isolator 2 is in a released state, the earth switch 6 is in a connected state.

The earth switch 6 includes the movable contact 6b, the fixed contact 6a, and an electric-field relaxation shield 6c that covers the fixed contact 6a. The fixed contact 6a and the electric-field relaxation shield 6c are provided at the lid plate 5b that blocks the end portion 12d. The movable contact 6b is supported integrally with the movable contact 2c by the insulating spacer 11 via the conductor 13b.

The view window 7 is provided on the isolator container 2a. The view window 7 is provided at a cylindrical portion including the end portion 12a of the isolator container 2a having the axis 50 as a center. The view window 7 has an oval shape (including an elliptical shape) with a long diameter being in the direction of the axis 50. The view window 7 is configured by blocking an oval shaped opening with a light-transmissive member 7a such as plate-like glass. The normal line of the light-transmissive member 7a is directed in a direction toward the axis 50, being a central axis of the cylindrical portion described above. The view window 7 is provided at a position facing the movable contact 2c, or at a position facing a contact point between the movable contact 2c and the fixed contact 2b, so that the motion of the movable contact 2c of the isolator 2 and the connection status thereof can be observed well. The contact point between the movable contact 2c and the fixed contact 2b is present within the visible range seen through the view window 7.

As illustrated in FIGS. 3 and 4, the length of the long diameter of the view window 7 and a circumferential position thereof in the isolator container 2a are determined so that both the surface of the insulating spacer 10 and the surface of the insulating spacer 11 are present within the visible range of the view window 7. That is, by enlarging the long diameter of the view window 7 toward the side of the insulating spacer 10, the surface of the insulating spacer 10 can be brought within the visible range. Further, by enlarging the long diameter of the view window 7 toward the side of the insulating spacer 11 and adjusting the circumferential position thereof in the isolator container 2a, the surface of the insulating spacer 11 can be established within the visible range therethrough.

Specifically, as illustrated in FIG. 2, the view window 7 is provided on an opposite side to the end portion 12b, putting the axis 50 therebetween when the isolator container 2a is viewed in a planar view from a direction perpendicular to a plane including the axes 50 and 51. Alternatively, as illustrated in FIG. 3, an angle formed between the circumferential position of the view window 7 and the circumferential position of the end portion 12b (an angle formed between the normal line of the light-transmissive member 7a and the axis 51) needs to be larger than at least 90 degrees. In FIG. 3, this angle is set to, for example, 135 degrees. This angle is set to 180 degrees most preferably in view of the objective to visually observe the surface of the insulating spacer 11. However, because the end portion 12d is provided in the isolator container 2a, the view window 7 can be manufactured more easily by setting the angle to be smaller than 180 degrees.

In FIG. 3, the visible range seen through the view window 7 in a plane perpendicular to the axis 50 is indicated by diagonal lines. From FIG. 3, it is understood that the surface of the insulating spacer 11 is present within the visible range seen through the view window 7. Further, in FIG. 4, the visible range seen through the view window 7 in a plane including the axis 50 is indicated by diagonal lines. In FIG. 4, it is understood that the surface of the insulating spacer 10 and the surface of the insulating spacer 11 are present within the visible range seen through the view window 7. In FIG. 4, the angle of the visible range is about 160 degrees.

In this manner, the view window 7 is provided in order to observe not only the motion of the movable contact 2c of the isolator 2 and the connection status thereof but also the surface state of the insulating spacer 10 and the surface state of the insulating spacer 11. The surface of the insulating spacer 10 can be brought into within the visible range seen through the view window 7, regardless of the position in the circumferential direction of the isolator container 2a, by adjusting the length of the long diameter.

By forming the light-transmissive member 7a with a fish-eye lens, the visible range seen through the view window 7 can be further enlarged.

The isolator container 2a is also provided with the view window 8 (earth-switch view window) on the side of the end portion 12d. The view window 8 has, for example, a circular shape, and is configured to be blocked by an opening with a light-transmissive member (not illustrated) such as plate-like glass. The view window 8 is provided at a position facing the movable contact 6b or at a position facing a contact point between the movable contact 6b and the fixed contact 6a, so that the motion of the movable contact 6b of the earth switch 6 and the connection status thereof can be observed well. The view window 8 is disposed such that the contact point between the movable contact 6b and the fixed contact 6a is included in the visible range viewed therethrough. Because the view window 7 is provided on the side of the end portion 12d, the view window 8 can be manufactured more easily by providing the view window 8 on the opposite side to the side where the view window 7 is provided, putting the axis 51 therebetween when the isolator container 2a is viewed in a planar view in the direction perpendicular to the plane including the axes 50 and 51.

Note that the view window 8 can be in an oval shape with its long diameter being in the direction of the axis 51, and the light-transmissive member thereof can be formed with a fish-eye lens. Accordingly, the surface of the insulating spacer 10 can be present within the visible range seen through the view window 8, thereby further improving reliability of inside observation.

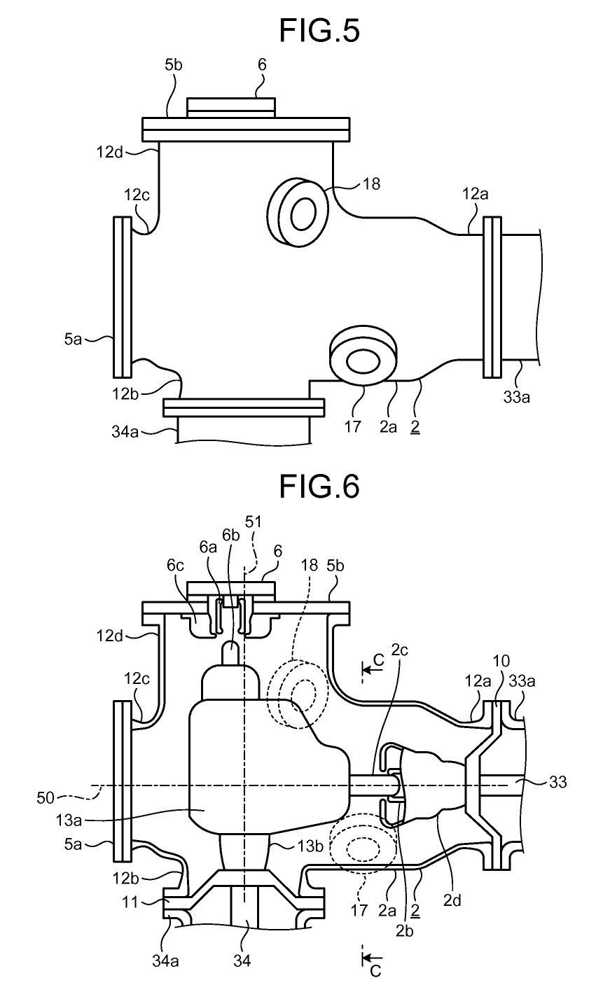

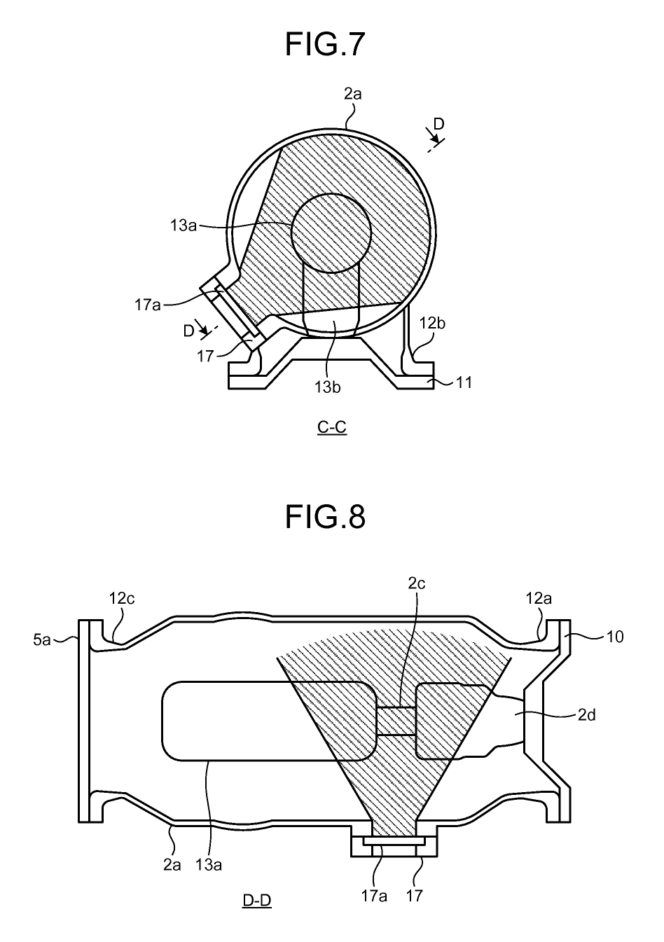

The present embodiment and a conventional configuration is compared in the following. FIG. 5 is a side view illustrating a configuration of a conventional gas-insulated switchgear; and FIG. 6 is a longitudinal sectional view illustrating the configuration of the conventional gas-insulated switchgear. FIG. 7 is a sectional view along the line C-C in FIG. 6, and FIG. 8 is a sectional view along the line D-D in FIG. 7. In FIG. 6, view windows 17 and 18 are both indicated by dotted lines. FIGS. 7 and 8 are intended to illustrate the visible range seen through the view window 17, and thus some parts of the configuration are omitted.

As illustrated in FIGS. 5 to 8, in the conventional gas-insulated switchgear, the view windows 17 and 18 are provided therein instead of the view windows 7 and 8 of the present embodiment. Because other configurations of the conventional gas-insulated switchgear are identical to those of the present embodiment, constituent elements identical to those illustrated in FIGS. 1 to 4 are denoted by like reference signs in FIGS. 5 to 8, and detailed explanations thereof will be omitted.

The view window 17 is provided at a cylindrical portion including the end portion 12a of the isolator container 2a, having the axis 50 as a center. The view window 17 has a circular shape, and it is configured by blocking an opening having a circular shape with a light-transmissive member 17a such as plate-like glass. The view window 17 is provided at a position facing the movable contact 2c, or at a position facing a contact point between the movable contact 2c and the fixed contact 2b so that the motion of the movable contact 2c of the isolator 2 and the connection status thereof can be observed well therethrough. The view window 17 is provided on a side where the end portion 12b is provided with respect to the axis 50 when viewed in a planar view from a direction perpendicular to a plane including the axes 50 and 51.

In FIG. 7, the visible range seen through the view window 17 in the plane perpendicular to the axis 50 is indicated by diagonal lines. In FIG. 8, the visible range seen through the view window 17 in a plane including the axis 50 is indicated by diagonal lines. In FIG. 8, the angle of the visible range seen through the view window 17 is about 60 degrees, and the visible range is narrower when compared to the present embodiment; and the surface of the insulating spacer 10 is outside the visible range. This is because the view window 17 has a circular shape. In the example illustrated therein, it is difficult to visually observe the surface of the insulating spacer 11 in the first place due to the circumferential arrangement of the view window 17. Even if the circumferential position of the view window 17 is the same as that in the present embodiment, it is still difficult to bring the surface of the insulating spacer 11 within the visible range because the view window 17 has a circular shape and the visible range thereof is limited in the direction of the axis 51.

In this manner, the purpose of the view window 17 is only to observe the motion of the movable contact 2c of the isolator 2 and the connection status thereof; and the view window 17 has a circular shape and a small window size. Thus the visible range that can be visually observed from outside is limited. Therefore, it is difficult to observe the internal status other than in the vicinity of the contact point, and it is also difficult to observe the surface state of the insulating spacers 10 and 11.

Furthermore, the view window 18 has a circular shape similarly to the view window 8. The view window 18 is provided at a position facing the movable contact 6b, or at a position facing a contact point between the movable contact 6b and the fixed contact 6a, so that the motion of the movable contact 6b of the earth switch 6 and the connection status thereof can be observed well. Therefore, it is difficult to make the surfaces of the insulating spacers 10 and 11 be present within the visible range seen through the view window 18, which is not the case with the view window 8.

As described above, according to the present embodiment, by forming the view windows 7 for the purpose of observing the motion of the movable contact 2c of the isolator 2 and the connection status thereof so as to have an oval shape with the long diameter being in the direction of the axis 50 and by adjusting the circumferential position thereof in the isolator container 2a, both surfaces of the insulating spacers 10 and 11 can be within the visible range.

In the isolator container 2a, generally, electric discharge may occur in the boundary between the insulating spacer 10 and metal (the electric-field relaxation shield 2d) or in the boundary between the insulating spacer 11 and metal (the conductor 13b); and such electric discharges become a cause of insulation breakdown. Further, when an electric discharge has occurred, a trace is left on the surfaces of the insulating spacers 10 and 11 and on the inside of the isolator container 2a. Accordingly, by visually checking the surface, the presence of the occurrence of electric discharge can be observed.

Therefore, according to the present embodiment, by using the view window 7, the surfaces of the insulating spacers 10 and 11 can be visually checked, thereby enabling one to observe the presence of the occurrence of electric discharge.

However, conventionally, the visible range seen through the view window 17 has been limited, and it has been difficult to observe the surface states of the insulating spacers 10 and 11 through the view window 17. Therefore, in order to observe the surface state, the device needs to be dissolved so that the operation cost of the dismantling work and the power cut time during the dissolution are needed. Meanwhile, according to the present embodiment, the dismantling work for inspecting the surface state of the insulating spacers 10 and 11 is not required, and thus the operation cost of the dismantling work and the power cut time during the dismantling period are not required. Further, the internal state of the isolator container 2a can always be observed widely from outside, which leads to the improvement in the quality of the gas-insulating switchgear.

If the number of view windows is increased, the surface states of the insulating spacers 10 and 11 can be individually observed therethrough. However, because the view window is blocked by the light-transmissive member such as a lens, the view window may become fragile in terms of its strength, and in a case when the number of view windows is increased, the design strength needs to be re-designed as to whether the isolator container 2a can endure a high-pressure gas. Further, an increase in the number of view windows also leads to an increase in the manufacturing cost of the isolator container 2a.

According to the present embodiment, the surface states of both the insulating spacers 10 and 11 can be observed without increasing the number of view windows.

In the technique of Patent Literature 1, the inspection range can be enlarged by rotating the body of the internal inspection device. However, a specific device for inspecting (the internal inspection device) having a more complicated structure than the view window needs to be provided. Meanwhile, according to the present embodiment, it is adequate if only the shape and the position of the view window 7 are adjusted, which accordingly leads to a simple configuration and cost reduction.

Furthermore, by using a fish-eye lens instead of a normal lens as the light-transmissive member 7a, the internal state thereof can be observed over a wider range.

According to the present embodiment, the isolator 2 is provided with an earth switch. However, the present embodiment can be similarly applied to a case where the earth switch 6 is provided in the isolator container 2a separately from the isolator 2. Further, the earth switch 6 may not be provided in the isolator container 2a.

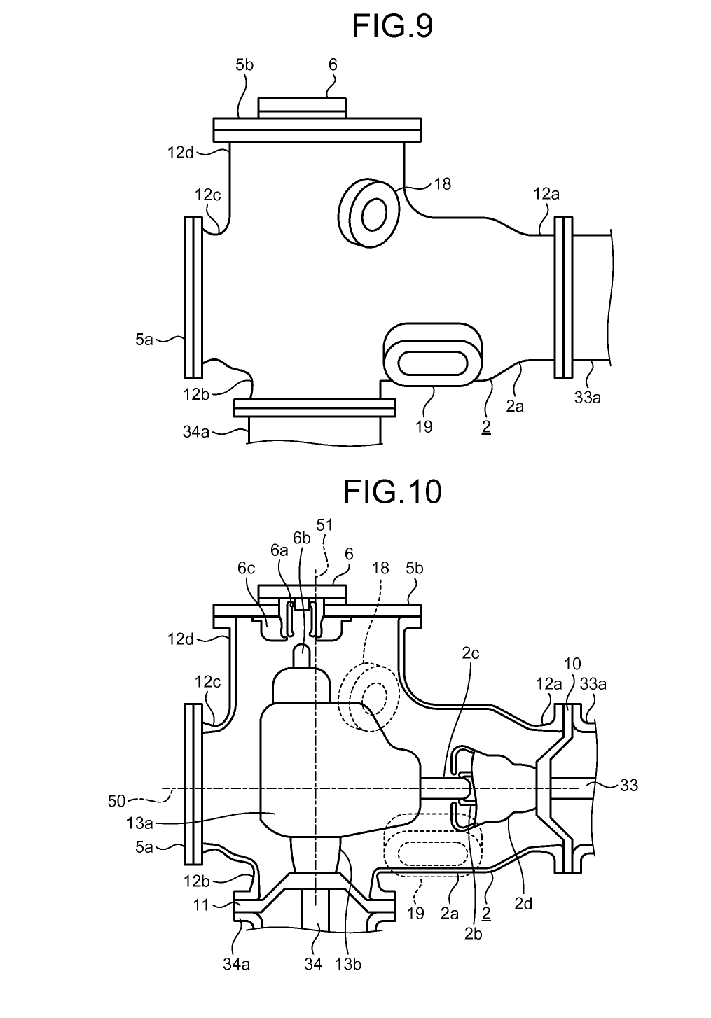

FIG. 9 is a side view illustrating a configuration of a gas-insulated switchgear according to a modification of the present embodiment. FIG. 10 is a longitudinal section view illustrating the configuration of the gas-insulated switchgear according to the modification of the present embodiment. In FIG. 10, the view window 18 and a view window 19 are both indicated by dotted lines.

As illustrated in FIGS. 9 and 10, in the gas-insulated switchgear according to the present modification, the view windows 19 and 18 are provided instead of the view windows 7 and 8 of the present embodiment. Because other configurations of the gas-insulated switchgear according to the present modification are identical to those of the present embodiment, constituent elements identical to those illustrated in FIGS. 1 and 2 are denoted by like reference signs in FIGS. 9 and 10, and detailed explanations thereof are be omitted.

The view window 19 is provided at a cylindrical portion including the end portion 12a of the isolator container 2a, the cylindrical portion having the axis 50 as a center. The view window 19 has an oval shape with the long diameter being in the direction of the axis 50. The view window 19 is configured by blocking an opening having an oval shape with a light-transmissive member (not illustrated) such as plate-like glass. The view window 19 is provided at a position facing the movable contact 2c, or at a position facing a contact point between the movable contact 2c and the fixed contact 2b, so that the motion of the movable contact 2c of the isolator 2 and the connection status thereof can be observed well. The contact point between the movable contact 2c and the fixed contact 2b is included in the visible range viewed through the view window 19. The view window 19 is provided on the side of the end portion 12b with respect to the axis 50 when the isolator container 2a is viewed in a planar view from a direction perpendicular to the plane including the axes 50 and 51. Therefore, the surface of the insulating spacer 10 can be within the visible range seen through the view window 19 by adjusting the length of the long diameter thereof. By using a fish-eye lens as the light-transmissive member of the view window 19, the visible range thereof can be further enlarged. The view window 18 is identical to those illustrated in FIGS. 5 to 8, and thus explanations thereof are omitted.

According to the present modification, by using the view window 19, not only can the motion of the movable contact 2c of the isolator 2 and the connection status thereof be observed, but the surface state of the insulating spacer 10 can also be observed.

### Second Embodiment

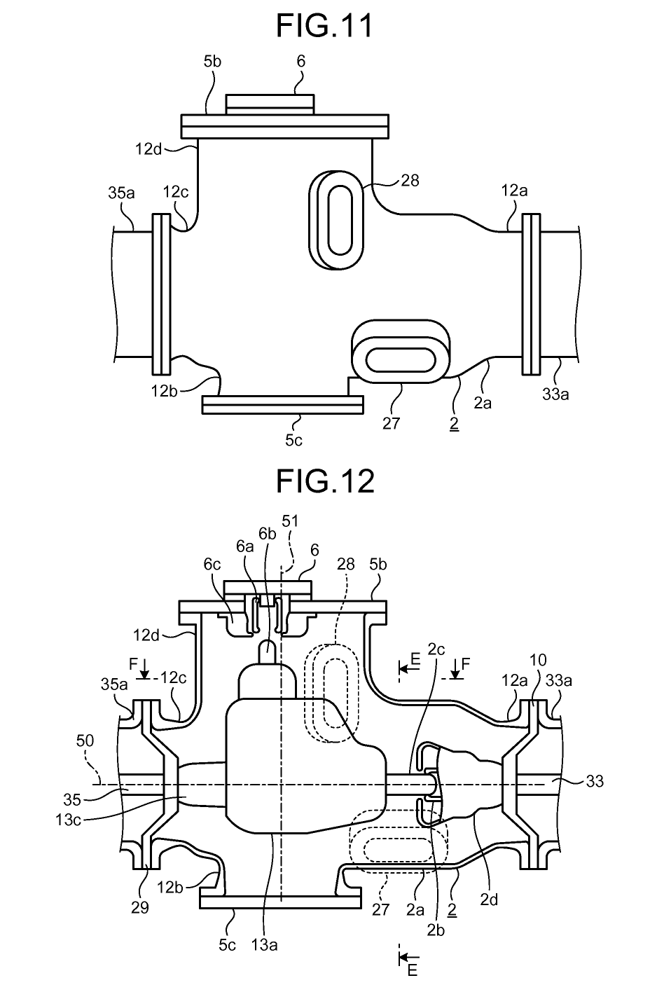

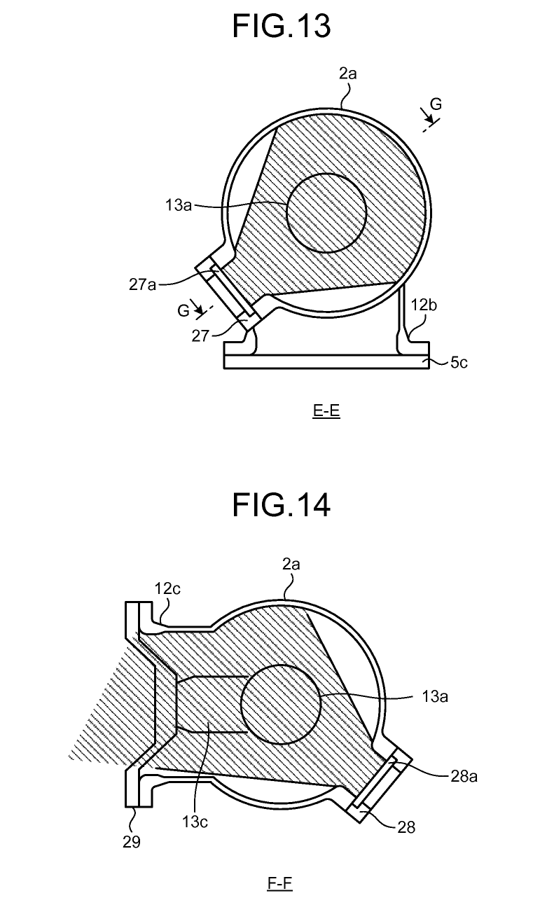

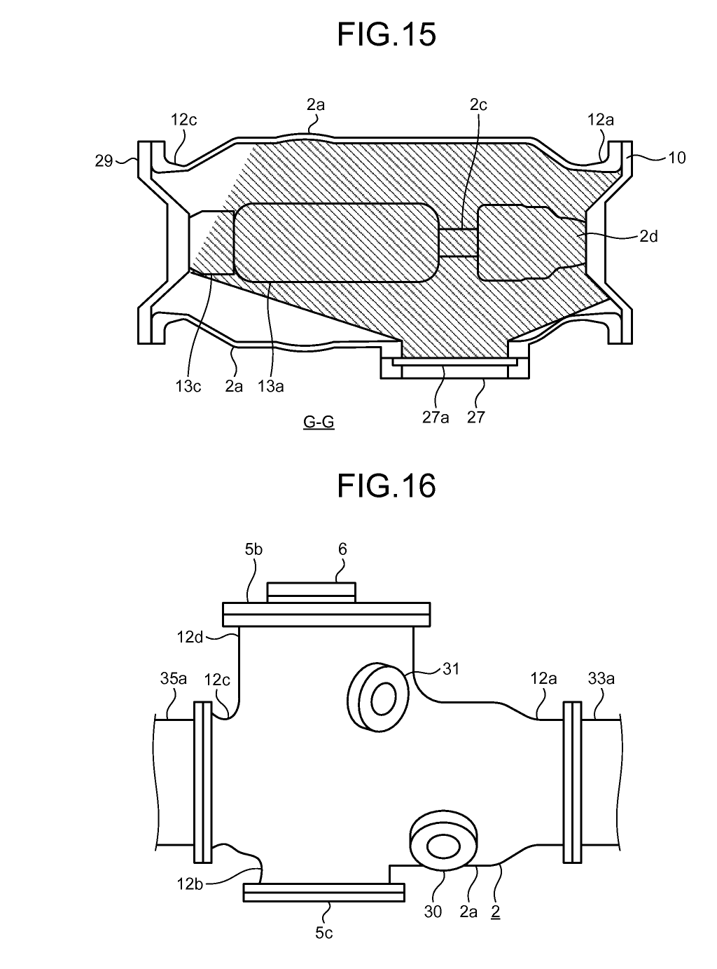

FIG. 11 is a side view illustrating a configuration of a gas-insulated switchgear according to the present embodiment. FIG. 12 is a longitudinal sectional view illustrating the configuration of the gas-insulated switchgear according to the present embodiment. FIG. 13 is a sectional view along the line E-E in FIG. 12, FIG. 14 is a sectional view along the line F-F in FIG. 12, and FIG. 15 is a sectional view along the line G-G in FIG. 13.

As illustrated in FIGS. 11 to 15, the gas-insulated switchgear according to the present embodiment includes the isolator 2 with an isolator body being accommodated in the isolator container 2a; the conductor 33 (first conductor) accommodated in the container 33a (first container) connected to the end portion 12a (first end portion) of the isolator container 2a and connected to the isolator 2; and a conductor 35 (second conductor) accommodated in a container 35a (second container) connected to the end portion 12c (second end portion) of the isolator container 2a and connected to the isolator 2. The isolator container 2a and the containers 33a and 35a are tanks respectively made of metal; and insulating gas, for example, sulfur hexafluoride gas is filled and sealed therein. The conductors 33 and 35 are respectively connected to another gas-insulated device (not illustrated). The gas-insulated switchgear according to the present embodiment is applied to both of the phase-separated type and the three-phase batch-type gas-insulated switchgear.

The isolator 2 is a called an “isolator with an earth switch”, in which the isolator body and the earth switch 6 are integrally formed in the isolator container 2a. The isolator container 2a has a substantially linear shape along the axis 50, and it includes cylindrical end portions 12a and 12c, having the axis (first axis or second axis) as a central axis.

Specifically, the isolator container 2a includes the cylindrical end portion 12b having the axis 51 (third axis) substantially orthogonal to the axis 50 as a central axis, and it has the end portion 12d provided on an opposite side to the end portion 12b in the direction of the axis 51. However, an opening at the end portion 12b is blocked by a lid plate 5c and an opening at the end portion 12d is blocked by the lid plate 5b.

The end portion 12a of the isolator container 2a is connected to one end portion of the container 33a via the insulating spacer 10 (first insulating spacer). That is, the insulating spacer 10 is provided at the opening of the end portion 12a. The insulating spacer 10 is formed of, for example, an epoxy resin. The insulating spacer 10 insulates and supports a fixed portion of the isolator 2 including the fixed contact 2b and the electric-field relaxation shield 2d covering the fixed contact 2b of the isolator 2, and it also insulates and supports the conductor 33 connected to the fixed contact 2b. The insulating spacer 10 also supports the fixed contact 2b via the electric-field relaxation shield 2d. Although a fixed-side electrode and the like connected to the fixed contact 2b are present inside the electric-field relaxation shield 2d, illustrations thereof are omitted.

The end portion 12c of the isolator container 2a is connected to one end portion of the container 35a via an insulating spacer 29 (second insulating spacer). That is, the insulating spacer 29 is provided at the opening of the end portion 12c. The insulating spacer 29 is formed of, for example, an epoxy resin. The insulating spacer 29 insulates and supports a conductor 13c on a movable side of the isolator 2 and the conductor 35, which is connected to the conductor 13c. The conductor 13c is connected to the movable contact 2c of the isolator 2 and the movable contact 6b of the earth switch 6. Although a movable-side electrode to which the movable contacts 2c and 6b and the conductor 13c are connected is present inside of the electric-field relaxation shield 13a, illustrations thereof are omitted.

The movable contact 2c can perform a reciprocal motion along the axis 50, and it comes into contact with the fixed contact 2b or comes away from the fixed contact 2b. Further, the movable contact 6b can perform a reciprocal motion along the axis 51, and it comes into contact with the fixed contact 6a of the earth switch 6 or it comes away from the fixed contact 6a. Although illustrations of the configuration inside the electric-field relaxation shield 13a are omitted, the movable portions are integrally formed so that, when the isolator 2 is in a connected state, the earth switch 6 is in a released state, and when the isolator 2 is in a released state, the earth switch 6 is in a connected state.

The earth switch 6 includes the movable contact 6b, the fixed contact 6a, and the electric-field relaxation shield 6c that covers the fixed contact 6a. The fixed contact 6a and the electric-field relaxation shield 6c are provided in the lid plate 5b that blocks the end portion 12d. The movable contact 6b is supported integrally with the movable contact 2c by the insulating spacer 29 via the conductor 13c.

As described above, the isolator 2 of the present embodiment has the same structure as that of the first embodiment, except that the isolator 2 of the present embodiment has a linear shape.

A view window 27 is provided in the isolator container 2a. The view window 27 is provided in a cylindrical portion including the end portion 12a of the isolator container 2a, having the axis 50 as a center. The view window 27 has an oval shape (including an elliptical shape) with the long diameter being in the direction of the axis 50. The view window 27 is configured by blocking an opening having an oval shape with a light-transmissive member 27a such as plate-like glass. A normal line of the light-transmissive member 27a is directed in a direction toward the axis 50, being a central axis of the cylindrical portion described above. The view window 27 is provided at a position facing the movable contact 2c, or at a position facing a contact point between the movable contact 2c and the fixed contact 2b, so that the motion of the movable contact 2c of the isolator 2 and the connection status thereof can be observed well. The view window 27 has the contact point between the movable contact 2c and the fixed contact 2b within its visible range.

Furthermore, the length of the long diameter of the view window 27 is determined so that the surface of the insulating spacer 10 is within the visible range the view window 27. That is, by enlarging the long diameter of the view window 27 toward the side of the insulating spacer 10, the surface of the insulating spacer 10 can be brought within the visible range. Further, the view window 27 is provided on the side of the end portion 12b with respect to the axis 50 when the isolator container 2a is viewed in a planar view from the direction perpendicular to the plane including the axes 50 and 51. The circumferential position of the view window 27 can be at another position so long as it does not become difficult to create the view window 27 by bringing the view window 27 and a view window 28 close to each other.

The isolator container 2a is also provided with the view window 28 (earth-switch view window). The view window 28 is provided on the side of the end portion 12d. The view window 28 has an oval shape (including an elliptical shape) with the long diameter being in the direction of the axis 51. The view window 28 is configured by blocking an opening having an oval shape with a light-transmissive member 28a such as plate-like glass. A normal line of the light-transmissive member 28a is directed in a direction toward the axis 51, being a central axis of the end portion 12d. The view window 28 is provided at a position facing the movable contact 6b, or at a position facing a contact point between the movable contact 6b and the fixed contact 6a, so that the motion of the movable contact 6b of the earth switch 6 and the connection status thereof can be observed well. The view window 28 has the contact point between the movable contact 6b and the fixed contact 6a within visible range of the view window 28.

Furthermore, the length of the long diameter of the view window 28 is determined so that the surface of the insulating spacer 29 is within visible range of the view window 28. That is, by enlarging the long diameter of the view window 28 toward the side of the insulating spacer 29, the surface of the insulating spacer 29 can be brought within the visible range. Further, the view window 28 is provided on the side of the end portion 12a with respect to the axis 51 when the isolator container 2a is viewed in a planar view from the direction perpendicular to the plane including the axes 50 and 51.

In FIG. 13, the visible range seen through the view window 27 in the plane perpendicular to the axis 50 is indicated by diagonal lines. In FIG. 14, the visible range seen through the view window 28 in the plane perpendicular to the axis 51 is indicated by diagonal lines. From FIG. 14, it is understood that the surface of the insulating spacer 29 is within the visible range seen through the view window 28. In FIG. 15, the visible range seen through the view window 27 in the plane including the axis 50 is indicated by diagonal lines. From FIG. 15, it is understood that the surface of the insulating spacer 10 and a part of the surface of the insulating spacer 29 are within the visible range of the view window 27. In FIG. 15, the angle of the visible range of the view window 27 is about 160 degrees.

In this manner, the view window 27 is provided to observe not only the motion of the movable contact 2c of the isolator 2 and the connection status thereof, but also the surface state of the insulating spacer 10. Further, the view window 28 is provided to observe not only the motion of the movable contact 6b of the earth switch 6 and the connection status thereof, but also the surface state of the insulating spacer 29.

By using a fish-eye lens as the light-transmissive members 27a and 28a, the visible ranges of the view windows 27 and 28 can be further enlarged.

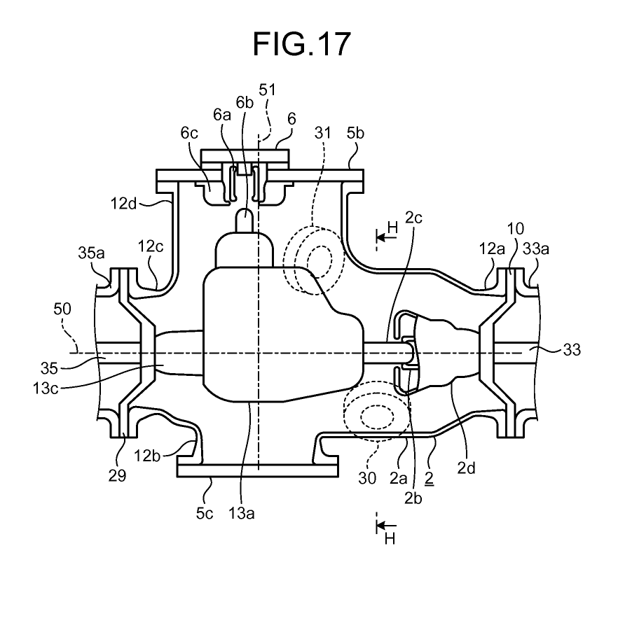

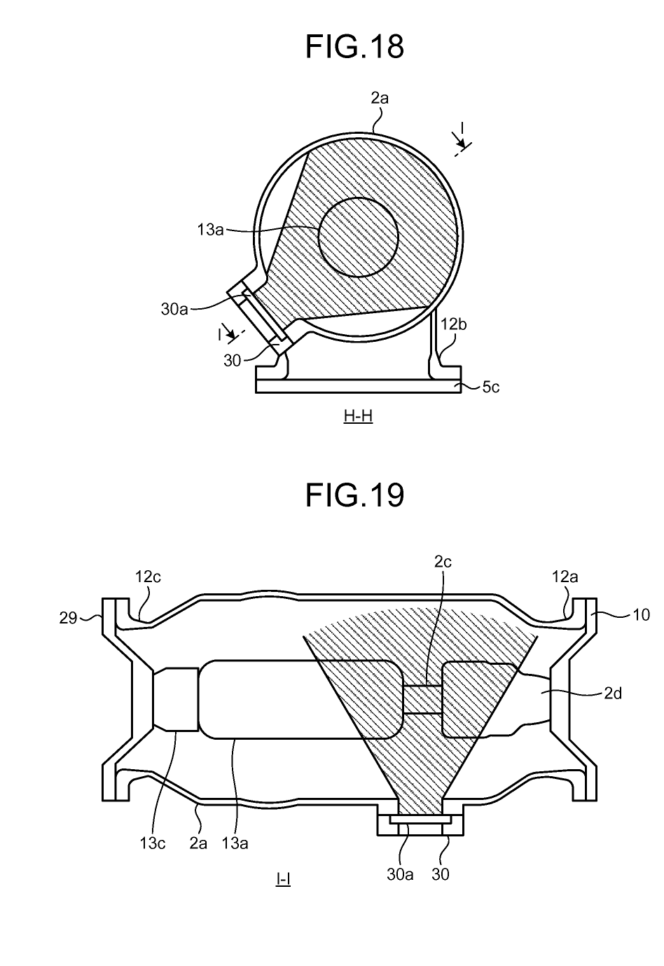

A comparison between the present embodiment and a conventional configuration is performed here. FIG. 16 is a side view illustrating a configuration of another conventional gas-insulated switchgear, and FIG. 17 is a longitudinal sectional view illustrating the configuration of the conventional gas-insulated switchgear. FIG. 18 is a sectional view along the line H-H in FIG. 17, and FIG. 19 is a sectional view along the line I-I in FIG. 18. In FIG. 17, view windows 30 and 31 are both indicated by a dotted line. FIGS. 18 and 19 are intended to illustrate a visible range seen through the view window 30, and thus some parts of the configuration are omitted.

As illustrated in FIGS. 16 to 19, in the conventional gas-insulated switchgear, the view windows 30 and 31 are provided instead of the view windows 27 and 28 of the present embodiment. Because other configurations of the conventional gas-insulated switchgear are identical to those of the present embodiment, constituent elements identical to those illustrated in FIGS. 11 to 15 are denoted by like reference signs in FIGS. 16 to 19, and detailed explanations thereof will be omitted.

The view window 30 is provided in a cylindrical portion including the end portion 12a of the isolator container 2a, having the axis 50 as a center. The view window 30 has a circular shape, and is configured by blocking an opening having a circular shape with a light-transmissive member 30a such as plate-like glass. The view window 30 is provided at a position facing the movable contact 2c, or at a position facing a contact point between the movable contact 2c and the fixed contact 2b, so that the motion of the movable contact 2c of the isolator 2 and the connection status thereof can be observed well. Further, the view window 30 is provided on a side where the end portion 12b is provided with respect to the axis 50 when viewed in a planar view from the direction perpendicular to the plane including the axes 50 and 51.

The isolator container 2a is also provided with the view window 31. The view window 31 is provided on the side of the end portion 12d of the isolator container 2a. The view window 31 has a circular shape, and it is configured by blocking an opening having a circular shape with a light-transmissive member (not illustrated) such as plate-like glass. The view window 31 is provided at a position facing the movable contact 6b, or at a position facing a contact point between the movable contact 6b and the fixed contact 6a, so that the motion of the movable contact 6b of the earth switch 6 and the connection status thereof can be observed well. Further, the view window 31 is provided on a side where the end portion 12a is provided with respect to the axis 51 when viewed in a planar view from the direction perpendicular to the plane including the axes 50 and 51.

In FIG. 18, the visible range seen through the view window 30 in the plane perpendicular to the axis 50 is indicated by diagonal lines. In FIG. 19, the visible range seen through the view window 30 in the plane including the axis 50 is indicated by diagonal lines. In FIG. 19, the angle of the visible range seen through the view window 30 is about 60 degrees, which is narrower when compared to the present embodiment, and both surfaces of the insulating spacers 10 and 29 are outside the visible range. This is because the view window 30 has a circular shape. The view window 31 also has a circular shape, and the visible range thereof is narrow and the surface of the insulating spacer 29 is outside the visible range.

As described above, according to the present embodiment, even in the case of the isolator 2 having a linear shape, by forming the view window 27 provided in order to observe the motion of the movable contact 2c of the isolator 2 and the connection status thereof in an oval shape with the long diameter being in the direction of the axis 50, the surface of the insulating spacer 10 can be brought within the visible range of the view window 27. Further, by forming the view window 28 provided in order to observe the motion of the movable contact 6b of the earth switch 6 and the connection status thereof in an oval shape with the long diameter being in the direction of the axis 51, the surface of the insulating spacer 29 can be brought within the visible range of the view window 28.

Therefore, according to the present embodiment, by using the view windows 27 and 28, the surfaces of the insulating spacers 10 and 29 can be visually checked, thereby enabling the presence of the occurrence of electric discharge to be observed.

According to the present embodiment, the surface states of both the insulating spacers 10 and 29 can be observed without providing an increased number of view windows.

Furthermore, by respectively using a fish-eye lens for the view windows 27 and 28, the internal state of the isolator container 2a can be observed in a wider range.

According to the present embodiment, the isolator 2 is the one that is provided with an earth switch. However, the present embodiment can be similarly applied to a case where the earth switch 6 is provided in the isolator container 2a separately from the isolator 2. Further, the earth switch 6 may not be provided in the isolator container 2a at all.

According to the first and second embodiments, the isolator 2 and the earth switch 6 respectively move the contacts linearly. However, the movable contact can be made to be blade-shaped and can be rotatably driven.

The arrangement of the view windows described in the first and second embodiments is only an example, and it can be changed as appropriate so long as the view window has a similar insulating spacer within the visible range of the view window.

### INDUSTRIAL APPLICABILITY

As described above, the present invention is useful as a gas-insulated switchgear.

### REFERENCE SIGNS LIST

2 isolator, 2a isolator container, 2c, 6b movable contact, 2d, 6c, 13a electric-field relaxation shield, 5a to 5c lid plate, 6 earth switch, 6a fixed contact, 6b movable contact, 7, 8, 17, 18, 19, 27, 28, 30, view window, 7a, 27a, 28a, 30a light-transmissive member, 10, 11, 29 insulating spacer, 12a to 12d end portion, 13b, 13c, 33 to 35 conductor, 33a to 35a container, 50, 51 axis.

1. A gas-insulated switchgear comprising an isolator that includes:
an isolator container provided with
a first end portion having a first axis as a central axis and
a second end portion different from the first end portion and having a second axis orthogonal or identical to the first axis as a central axis,
an isolator body
accommodated in the isolator container,
connected to a first conductor accommodated in a first container connected to the first end portion, and
connected to a second conductor accommodated in a second container connected to the second end portion,
a first insulating spacer provided at the first end portion so as to support a fixed contact of the isolator body and the first conductor,
a second insulating spacer provided at the second end portion so as to support a conductor on a movable side connected to a movable contact of the isolator body and the second conductor, and
a view window
that is provided in a cylindrical portion including the first end portion of the isolator container, having the first axis as a central axis,
that is provided at
a position facing the movable contact of the isolator body or
a position facing a contact point between the movable contact of the isolator body and the fixed contact of the isolator body, and
that allows at least the contact point to be within a visible range of the view window, wherein
the view window is configured to include a light-transmissive member that blocks an opening having an oval shape with a long diameter being in a direction of the first axis, and
a length of the long diameter is set such that a surface of the first insulating spacer is present within the visible range.

2. The gas-insulated switchgear according to claim 1, wherein
the first axis is orthogonal to the second axis,
the isolator container has a substantially L-shaped form,
the view window is provided on an opposite side to the second end portion, putting the first axis therebetween when the isolator container is viewed in a planar view in a direction perpendicular to a plane including the first and second axes, and
the length of the long diameter and a circumferential position thereof in the isolator container are set such that a surface of the second insulating spacer is also within the visible range.

3. The gas-insulated switchgear according to claim 2, wherein
the isolator includes an earth switch in the isolator container,
the isolator container is provided with a third end portion on an opposite side to the second end portion in a direction of the second axis,
a fixed contact of the earth switch is provided in a lid plate that blocks the third end portion,
a movable contact of the earth switch
is connected to a conductor on the movable side and
is supported by the second insulating spacer, and
the isolator container is provided with an earth-switch view window on a side of the third end portion, the earth-switch view window being provided at a position facing the movable contact of the earth switch or at a position facing a contact point between the movable contact of the earth switch and the fixed contact of the earth switch such that at least the contact point is included within a visible range of the earth-switch view window.

4. The gas-insulated switchgear according to claim 3, wherein
the earth-switch view window is provided on an opposite side to the first end portion, putting the second axis therebetween when the isolator container is viewed in a planar view in a direction perpendicular to a plane including the first and second axes.

5. The gas-insulated switchgear according to claim 2, wherein
the light-transmissive member is a fish-eye lens.

6. The gas-insulated switchgear according to claim 1, wherein
the first axis is identical to the second axis,
the isolator container has a substantially linear shape,
the isolator includes an earth switch in the isolator container,
the isolator container is provided with a third end portion having a third axis orthogonal to the first axis, as a central axis,
a fixed contact of the earth switch is provided at a lid plate that blocks the third end portion,
a movable contact of the earth switch is connected to a conductor on the movable side and is supported by the second insulating spacer,
an earth-switch view window is provided on a side of the third end portion in the insulator container,
the earth-switch view window being provided on a side of the first end portion with respect to the third axis when the isolator container is viewed in a planar view in a direction perpendicular to a plane including the first and third axes and being provided at a position facing the movable contact of the earth switch or at a position facing a contact point between the movable contact of the earth switch and the fixed contact of the earth switch, such that the contacts are included in a visible range of the earth-switch view window,
the earth-switch view window is configured to include a light-transmissive member that blocks an opening having an oval shape with a long diameter being in a direction of the third axis, and
a length of the long diameter is set such that a surface of the second insulating spacer is within the visible range of the earth-switch view window.

7. The gas-insulated switchgear according to claim 6, wherein
both a light-transmissive member of the view window and a light-transmissive member of the earth-switch view window are a fish-eye lens.
